(19) United States
(12) Patent Application Publication
(10) Pub. No.: US 2004/0011012 A1
(43) Pub. Date: Jan. 22, 2004

(54) Rotary machine

(76) Inventor: Ian Bennett, Gerrards Cross (GB)

Correspondence Address: SMITH-HILL AND BEDELL, 12670 N W BARNES ROAD, SUITE 104, PORTLAND, OR, 97229

(21) Appl. No.: 10/620,484

(22) Filed: Jul. 15, 2003

(30) Foreign Application Priority Data
Jul. 19, 2002 (GB) 0216781.5

(51) Int. Cl. B01D 45/00

(52) U.S. Cl. 55/406

(57) ABSTRACT

A rotary machine is disclosed having a rotor 11, a stator 16, and blade rows 12, 14 on the rotor and stator that impart a high swirl component to gases flowing through the machine so that the denser impurities are deflected radially outwards by centripetal action onto the inner wall of the stator of the machine. A ramped guide surface is provided on the inner wall 17 of the stator along which any impurities separated by the centripetal action from the main gas stream are entrained by the main gas stream and guided to flow from the gas intake side to the gas outlet side of the machine. The guide surface is radially stepped to resist only reverse flow of the separated impurities back towards the gas intake side of the machine and serves at the downstream end of the machine to discharge the separated impurities back into the main gas stream for the impurities to exit from the machine with the main gas stream.

### FIELD OF THE INVENTION

The present invention relates to a rotary machine, which term is used herein to refer to a compressor or a turbine that is made up of a rotor and a stator, carrying rotating and stationary rows of blades, respectively.

### BACKGROUND OF THE INVENTION

Rotary machines have been used as compressors to produce supplies of compressed gas in a wide variety of industrial applications. In most such applications, the rotary machines are only used to compress clean gas and accordingly there is no risk of damage to the machines from impurities in the intake gas.

There are however applications where it is impossible to avoid droplets and solid particles in the intake gas. One such application is in a downhole compressor that has been proposed for use in the oil and gas industry to help extract gas from a well and thereby extend the well's productive life. In this application, a compressor is lowered into a bore hole and operated to pump gas out of the well. As in this case the compressor acts to extract gas taken directly from a well, it is inevitable that it will carry some impurities in the form of liquid droplets and solid particles.

The reliability of a compressor in such an application is paramount, as it is not commercially viable to stop production from a well so that the downhole compressor can be recovered for servicing at regular intervals. On the contrary, it is desirable to be able to construct the compressor so that its expected life is comparable with that of the well.

It has previously been proposed in GB-A-2 001 707 to separate impurities from the main gas stream in a gas turbine by causing the gas to follow a helical path. The whirl component of the velocity forces dust and mist to the outer region of turbine and is removed through grooves or slots in the casing. The impurities collect in a separation chamber and are subsequently allowed to escape from the separation chamber through a drain hole.

In an application such as a downhole compressor, the above prior art reference may teach how to separate the impurities from the main gas stream but it does not teach what should be done with the impurities after they have been so separated. The separation chamber can only drain into a space under lower pressure, and this would mean returning the impurities to the intake side of the compressor for immediate recycling. This is not an acceptable solution as it would only be a question of time before the concentration of impurities in the intake gases reaches a saturation point. It is not possible to connect the separation chamber to the downstream end of the compressor as the higher pressure would result in the impurities being blown back into the compressor.

### OBJECT OF THE INVENTION

The present invention seeks to provide a rotary machine that can work in a downhole environment and that is tolerant to liquid droplets and particles in the intake gas, any such impurities present in the intake gas being managed in a manner such as not to impair the reliability of the machine nor its expected life by causing wear to the blade rows.

### SUMMARY OF THE INVENTION

In accordance with the present invention, there is provided a rotary machine having a rotor, a stator, and blade rows on the rotor and stator that impart a high swirl component to gases flowing through the machine so that the denser impurities are deflected radially outwards by centripetal action onto the inner wall of the stator of the machine, wherein a guide surface is provided on the inner wall of the stator along which any impurities separated by the centripetal action from the main gas stream are entrained by the main gas stream and guided to flow from the gas intake side to the gas outlet side of the machine, the guide surface being radially stepped to resist only reverse flow of the separated impurities back towards the gas intake side of the machine and being operative at the downstream end of the machine to discharge the separated impurities back into the main gas stream for the impurities to exit from the machine with the main gas stream.

In the invention, the impurities are separated from the main gas stream and are urged radially against the guide surface by centripetal action. Thereafter, the viscous drag of the main gas stream is relied upon to entrain the impurities and displace them toward the downstream end of the machine compressor despite the pressure difference between the ends of the machine. The steps in the guide surface do not interfere with the flow of the impurities towards the downstream end of the machine but prevent the differential pressure between the opposite ends of the machine from causing a reverse flow of the separated impurities back towards the gas intake side of the machine.

The guide surface may conveniently be formed by a stepped groove in the inner wall of the stator that only extends around part of the circumference of the stator. It is however alternatively possible for several such grooves of scallops to be placed in the path of the rotor blade. A still further possibility is for the entire inner surface to be constructed as a stepped surface being formed of a series of near conical sections that are separated from one another by sharp radial shoulder that prevent reverse gas and liquid flow.

### BRIEF DESCRIPTION OF THE DRAWINGS

The invention will now be described further, by way of example, with reference to the accompanying drawings, in which:

FIG. 1 is a schematic section of a rotary machine (not in accordance with the invention) which is of a type that naturally separates particulate matter and droplets,

FIG. 2 is a schematic partial view similar to that of FIG. 1 illustrating an embodiment of the invention, and

FIG. 3 is a view similar to that of FIG. 1 showing a further embodiment of the invention.

### DETAILED DESCRIPTION OF THE PREFERRED EMBODIMENTS

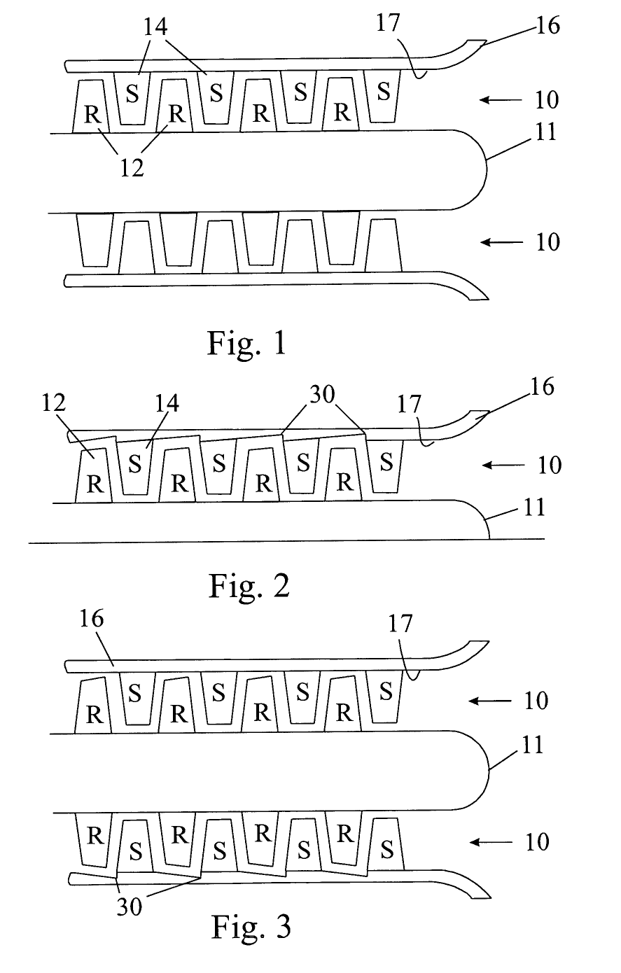

The rotary machines shown in FIG. 1 intended for use in a bore hole of a gas well. Gas flows in the direction of the arrows 10, being drawn from the well by the action of the compressor and pumped under pressure into the bore hole. The effect of the compressor is of course to create a higher pressure at its outlet side, shown to the left in all the figures in the drawings that at its intake side.

In FIG. 1, the compressor is formed by blade rows 12 on the rotor 11 and guide vanes 14 on the stator 16. The manner in which the gas is compressed is of course well known and need not be described in detail within the present context. The rotor 11 is driven by, for example, an electric motor (not shown) and each set of rotor blades and associated stationary guide vanes incrementally increases the gas pressure.

The blade rows 12 and guide vanes 14 naturally impart a significant component of swirl (i.e. a tangential component) to the gas entering at the intake end of the machine. The swirl induced by the intake nozzle has the effect of separating out the denser impurities which move out radially and adhere to the inner wall 17 of the stator 16, while the cleaner gas continues towards the downstream end of the machine.

The removal of the impurities protects the components of the machine, in particular the tips and surfaces of the blades and guide vanes, to improve the working life of the machine. However, once the liquid and solid impurities have been separated from the gas flow, it is necessary to dispose of them in a suitable manner. Allowing them to return to the intake side of the machine is not an acceptable solution as they will be continually recycled and they will gradually increase the level of impurities in the intake gas.

In the present invention, the inner wall 17 of the stator 16 includes a surface that includes sharp radial steps 30. The steps 30 allow the impurities to flow from the intake side of the machine to its outlet side while adhering to the inner wall of the stator, the liquid film being displaced along the surface by the viscous drag of the main gas stream. The steps 30 will however resist any flow in the opposite direction as a result of the positive pressure difference between the intake and outlet sides of the machine.

The embodiments of FIG. 2 is rotationally symmetrical about the axis of the rotor 11 and therefore only one side needs to be shown in the drawing. The guide surface 17 is in this case formed of a series of near conical sections that are separated from one another by sharp radial shoulders.

In the embodiment of FIG. 3, on the other hand, the stepped surface is formed as a groove that lies at the bottom of the machine so that the collection of impurities in the groove is assisted by gravity. In this respect, it should be noted that several grooves may be provided so as to ensure that one will lie near the bottom of the rotary machine.

The sections of the guide surface between the steps 30 may be continuously ramped as shown in FIG. 2, or they may in part be parallel to the axis of the rotor, as shown in the embodiment of FIG. 3. It is important however that there should not be any steps or ramped regions facing in the opposite direction and acting to impede progress of the impurities towards the downstream end of the machine.

It should be added that it is known to provide grooves in the wall of the stator and to extend the tips of the rotor blades into these grooves for the purpose of improving aerodynamic efficiency. The ramped regions in the present invention differ from such grooves in that they are ramped and the steps face in only one direction. Furthermore, if the groove that acts as a guide surface for the impurities does not extend all the way round the circumference of the blade tips cannot extend into it. Even if the stator wall is rotationally symmetrical, it is not desirable for the rotor blades to reach into the grooves as the aim of the invention is to keep the impurities that collect on the guide surface away from the blades to avoid blade tip erosion. It is furthermore recognised that the groove(s) in the present invention will result in a small penalty, rather than a gain, in terms of the aerodynamic performance of the machine.

1. A rotary machine having a rotor, a stator, and blade rows on the rotor and stator that impart a high swirl component to gases flowing through the machine so that the denser impurities are deflected radially outwards by centripetal action onto the inner wall of the stator of the machine, wherein a guide surface is provided on the inner wall of the stator along which any impurities separated by the centripetal action from the main gas stream are entrained by the main gas stream and guided to flow from the gas intake side to the gas outlet side of the machine, the guide surface being radially stepped to resist only reverse flow of the separated impurities back towards the gas intake side of the machine and being operative at the downstream end of the machine to discharge the separated impurities back into the main gas stream for the impurities to exit from the machine with the main gas stream.

2. A rotary machine as claimed in claim 1, wherein the guide surface is rotationally symmetrical about the axis of the rotor.

3. A rotary machine as claimed in claim 1, wherein the guide surface is formed by at least one groove in the inner wall of the stator that only extends around part of the circumference of the stator.

4. A rotary machine as claimed in claim 3, wherein the groove is arranged at the lower end of the stator such that separated impurities collect in the groove by the action of gravity.
